(19) United States
(12) Patent Application Publication
(10) Pub. No.: US 2021/0374005 A1
(43) Pub. Date: Dec. 2, 2021

(54) SYSTEMS AND METHODS FOR VERIFYING AND PRESERVING THE INTEGRITY OF BASIC INPUT/OUTPUT SYSTEM BEFORE POWERING ON OF HOST SYSTEM AND MANAGEMENT ENGINE

(71) Applicant: Dell Products L.P., Round Rock, TX (US)

(72) Inventors: Arun MUTHAIYAN, Round Rock, TX (US); Nasiha HRUSTEMOVIC, Austin, TX (US); Prashanth GIRI, Round Rock, TX (US); Sunil K. GATTU, Cedar Park, TX (US); Timothy M. LAMBERT, Austin, TX (US); Murali K. SOMAROUTHU, Austin, TX (US)

(73) Assignee: Dell Products L.P., Round Rock, TX (US)

(21) Appl. No.: 16/886,300

(22) Filed: May 28, 2020

(51) Int. Cl. G06F 11/14; G06F 9/4401; G06F 21/57; G06F 11/22

(52) U.S. Cl. CPC G06F 11/1417; G06F 11/2284; G06F 21/57; G06F 9/4401

(57) ABSTRACT

A method may include responsive to a power event associated with an information handling system, intercepting the power event and holding a platform controller hub of the information handling system from completing the power event to prevent execution of code of a basic input/output system of the information handling system, attempting to verify image integrity of the basic input/output system, and allowing the platform controller hub to complete the power event to allow execution of the code of the basic input/output system responsive to successful verification of the image integrity of the basic input/output system.

### TECHNICAL FIELD

The present disclosure relates in general to information handling systems, and more particularly to methods and systems for verifying and preserving the integrity of a basic input/output system (BIOS) before powering on of a host system and management engine of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A key component of almost every information handling system is the basic input/output system (BIOS). A BIOS may be a system, device, or apparatus configured to identify, test, and/or initialize one or more information handling resources of an information handling system, typically during boot up or power on of an information handling system. A BIOS may include boot firmware configured to be the first code executed by a processor of an information handling system when the information handling system is booted and/or powered on. As part of its initialization functionality, BIOS code may be configured to set components of the information handling system into a known state, so that one or more applications (e.g., an operating system or other application programs) stored on compatible media may be executed by a processor and given control of the information handling system and its various components.

Due to its importance within an information handling system architecture, a BIOS is often a target for malicious attacks. Compromised system security always poses a great threat for the operational success of industries and makes them vulnerable to attacks. In that regard, there is no guarantee that a firmware, such as BIOS, stored on a ROM can stay secured forever. Malicious actors are known for persistence in discovering ways to exploit vulnerabilities to gain access and compromise ROM firmware.

Because it is physically accessible and can be programmatically altered, a BIOS boot ROM may not be secure. Such a tampered BIOS image could expose the system to large scale security attacks. The longer a compromised BIOS image runs undetected/uncorrected, the larger is the risk of attacks.

Therefore, it is highly desirable to have a mechanism to perform an authenticity check on the BIOS image on the ROM and allow the host to boot, in order to ensure a continued uncompromised system security. It may also be critical to maintain a time window between verification of the BIOS image and a host booting off the verified image as small as possible to avoid intrusion.

### SUMMARY

In accordance with the teachings of the present disclosure, the disadvantages and problems associated with existing approaches to BIOS security may be reduced or eliminated.

In accordance with embodiments of the present disclosure, an information handling system may include a processor, a platform controller hub communicatively coupled to the processor, a basic input/output system comprising a program of instructions executable by the processor and configured to cause the processor to initialize one or more information handling resources of the information handling system, and a management controller communicatively coupled to the processor and the platform controller hub and configured to provide out-of-band management of the information handling system. The management controller may be further configured to, responsive to a power event associated with the information handling system, intercept the power event and hold the platform controller hub from completing the power event to prevent execution of code of the basic input/output system, attempt to verify image integrity of the basic input/output system, and allow the platform controller hub to complete the power event to allow execution of the code of the basic input/output system responsive to successful verification of the image integrity of the basic input/output system.

In accordance with these and other embodiments of the present disclosure, a method may include responsive to a power event associated with an information handling system, intercepting the power event and holding a platform controller hub of the information handling system from completing the power event to prevent execution of code of a basic input/output system of the information handling system, attempting to verify image integrity of the basic input/output system, and allowing the platform controller hub to complete the power event to allow execution of the code of the basic input/output system responsive to successful verification of the image integrity of the basic input/output system.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, responsive to a power event associated with an information handling system, intercept the power event and holding a platform controller hub of the information handling system from completing the power event to prevent execution of code of a basic input/output system of the information handling system, attempt to verify image integrity of the basic input/output system, and allow the platform controller hub to complete the power event to allow execution of the code of the basic input/output system responsive to successful verification of the image integrity of the basic input/output system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of an example method for verifying and preserving the integrity of a BIOS before powering on of a host system and management engine, in accordance with embodiments of the present disclosure.

### DETAILED DESCRIPTION

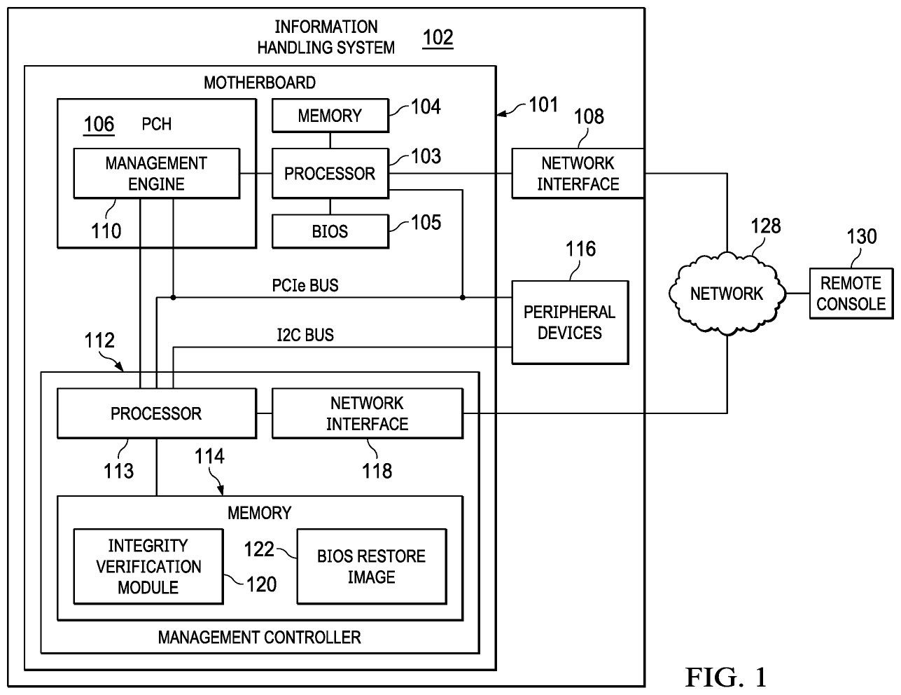

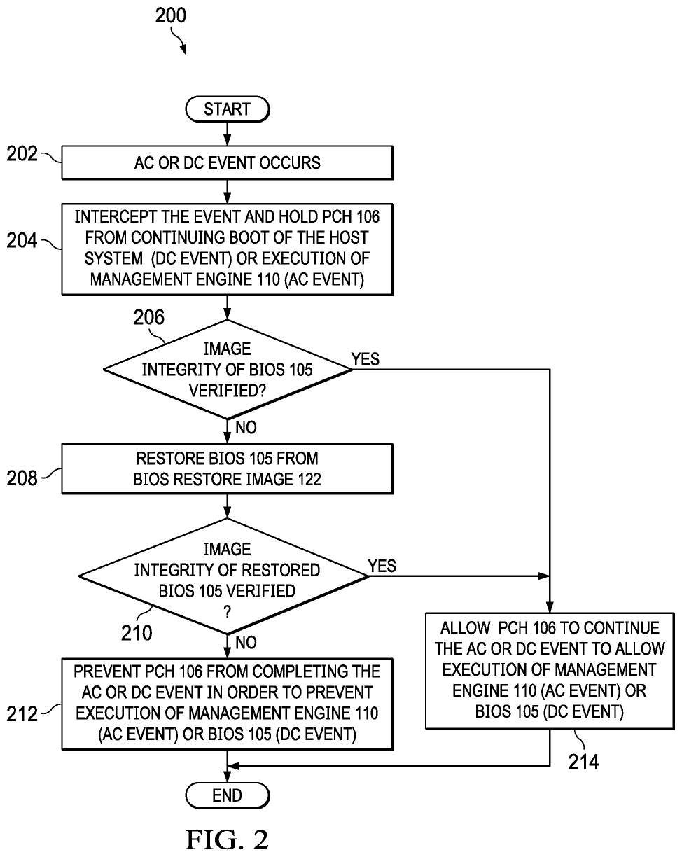

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an information handling system 102.

In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a motherboard 101, a network interface 108 communicatively coupled to a processor 103 of motherboard 101, and one or more peripheral devices 116 communicatively coupled to processor 103.

Motherboard 101 may include a circuit board configured to provide structural support for one or more information handling resources of information handling system 102 and/or electrically couple one or more of such information handling resources to each other and/or to other electric or electronic components external to information handling system 102. As shown in FIG. 1, motherboard 101 may include processor 103, a memory 104 communicatively coupled to processor 103, a platform controller hub (PCH) 106 communicatively coupled to processor 103, and a management controller 112 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. Although memory 104 is depicted in FIG. 1 as integral to motherboard 101, in some embodiments, all or a portion of memory 104 may reside external to motherboard 101.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be stored on a read-only memory of information handling system 102 and which may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

PCH 106 may be any system, device, or apparatus configured to control certain data paths (e.g., data flow between processor 103, memory 104, and peripherals) and support certain functions of processor 103. A PCH 106 may also be known as a “chipset” of an information handling system 102. One such function may include management engine 110. Management engine 110 may comprise hardware and/or firmware that enables remote out-of-band management for information handling system 102 in order to monitor, maintain, update, upgrade, and/or repair information handling system 102. In some embodiments, management engine 110 may include hardware and firmware compliant with Intel's Active Management Technology. In these and other embodiments, firmware components of management engine 110 may be stored as a part of BIOS 105 on a read-only memory of information handling system 102.

Management controller 112 may be configured to provide out-of-band management facilities for management of information handling system 102. Such management may be made by management controller 112 even if information handling system 102 is powered off or powered to a standby state. Management controller 112 may include a processor 113, memory 114, and an out-of-band network interface 118 separate from and physically isolated from in-band network interface 108. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. Memory 114 may have stored thereon software and/or firmware which may be read and executed by processor 113 for carrying out the functionality of management controller 112. As shown in FIG. 1, memory 114 may have stored thereon integrity verification module 120 and BIOS restore image 122.

Integrity verification module 120 may include any system, device, or apparatus configured to, as described in greater detail below, upon an alternating current (AC) or direct current (DC) event of information handling system 102, halt the AC or DC event in order to verify an integrity of BIOS 105. Integrity verification module 120 may also be configured to, upon verifying the integrity of BIOS 105, allow the AC or DC event to continue in order to allow execution of management engine 110 and/or BIOS 105. Integrity verification module 120 may also be configured to, upon determining integrity verification of BIOS 105 has failed, restore BIOS 105 from BIOS restore image 122 and verify the integrity of BIOS restore image 122 after restored as BIOS 105. Accordingly, integrity verification module 120 may be implemented as a program of instructions that may be read by and executed on processor 113 to carry out the functionality of integrity verification module 120. Thus, assuming a secure chain of trust extends to management controller 112 (provision of such chain of trust is outside the scope of this disclosure), management controller 112 via integrity verification module 120 may further extend such chain of trust to BIOS 105 (and management engine 110).

BIOS restore image 122 may comprise a “known-good” BIOS image that was known to have successfully booted on a prior boot session of information handling system 102.

Network interface 118 may comprise any suitable system, apparatus, or device operable to serve as an interface between management controller 112, network 128, and/or one or more other information handling systems. Network interface 118 may enable management controller 112 to communicate using any suitable transmission protocol and/or standard. In these and other embodiments, network interface 118 may comprise a network interface card, or “NIC.”

Network interface 108 may comprise any suitable system, apparatus, or device operable to serve as an interface between information handling system 102, network 128, and/or and one or more other information handling systems. Network interface 108 may enable information handling system 102 to communicate using any suitable transmission protocol and/or standard. In these and other embodiments, network interface 108 may comprise a network interface card, or “NIC.”

Each peripheral device 116 may be communicatively coupled to processor 103 and may generally include any information handling resource. As shown in FIG. 1, peripheral devices 116 may also be coupled to processor 113 via an inter-integrated circuit (I2C) bus and/or via a PCIe bus. Processor 113 can communicate directly to peripheral devices via PCIe except for some messages that require a PCIe root complex. For these messages, management engine 110 may serve as a proxy between processor 113 and peripheral devices 116.

Network 128 may be a network and/or fabric configured to couple information handling system 102, remote console 130, and/or one or more other information handling systems to one another. In these and other embodiments, network 128 may include a communication infrastructure, which provides physical connections, and a management layer, which organizes the physical connections and information handling systems communicatively coupled to network 128. Network 128 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 128 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 128 and its various components may be implemented using hardware, software, or any combination thereof.

Remote console 130 may comprise any information handling system including requisite hardware, software, and/or firmware for interfacing with management controller 112 via network interface 118 in order to facilitate remote management of information handling system 102 by remote console 130. In some embodiments, such remote management may be in accordance with Intelligent Platform Management Interface (IPMI) and/or another suitable interface or standard.

FIG. 2 illustrates a flow chart of an example method 200 for verifying and preserving the integrity of a BIOS before powering on of a host system and management engine, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, an AC or DC event may occur. For example, an AC event may comprise the coupling or “plugging in” of information handling system 102 to a power source. Because PCH 106 and management controller 112 may be powered from an auxiliary power supply physically separate from a main power supply which powers host system components (e.g., processor 103, memory 104, BIOS 105, peripheral devices 116), management controller 112 and PCH 106 (including management engine 110) may power on due to an AC event even though the host system components may be powered down. However, because firmware components of management engine 110 may be embodied in BIOS 105, it may be desirable to verify BIOS 105 responsive to an AC event. As another example, a DC event may be an interaction by a user or other stimulus indicating a desire to enable the main power supply and execute the host system of information handling system 102. Because the DC event leads to execution of BIOS 105, it may be desirable to verify BIOS 105 responsive to a DC event.

At step 204, responsive to the AC or DC event, integrity verification module 120 may intercept the event and hold PCH 106 from continuing boot of the host system (DC event) or execution of management engine 110 (AC event).

As step 206, integrity verification module 120 may attempt to verify the image integrity of BIOS 105. How integrity verification is performed is outside the scope of this disclosure, but integrity verification may comprise any suitable process for ensuring that BIOS 105 is an unaltered, uncompromised code image. If integrity verification module 120 successfully verifies the image integrity of BIOS 105, method 200 may proceed to step 214. If integrity verification module 120 is unable to verify the image integrity of BIOS 105, method 200 may proceed to step 208.

At step 208, responsive to integrity verification failure of BIOS 105, integrity verification module 120 may restore BIOS 105 from BIOS restore image 122. At step 210, integrity verification module 120 may attempt to verify the image integrity of BIOS 105 as restored from BIOS restore image 122. If integrity verification module 120 successfully verifies the image integrity of BIOS 105, method 200 may proceed to step 214. If integrity verification module 120 is unable to verify the image integrity of BIOS 105, method 200 may proceed to step 212.

At step 212, responsive to integrity verification failure of BIOS 105 as restored from BIOS restore image 122, integrity verification module 120 may prevent PCH 106 from completing the AC or DC event in order to prevent execution of management engine 110 (AC event) or BIOS 105 (DC event). After completion of step 212, method 200 may end.

At step 214, responsive to verification of the image integrity of BIOS 105, integrity verification module 120 may allow PCH 106 to continue the AC or DC event to allow execution of management engine 110 (AC event) or BIOS 105 (DC event). After completion of step 214, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a platform controller hub communicatively coupled to the processor;
a basic input/output system comprising a program of instructions executable by the processor and configured to cause the processor to initialize one or more information handling resources of the information handling system; and
a management controller communicatively coupled to the processor and the platform controller hub and configured to provide out-of-band management of the information handling system, the management controller further configured to, responsive to a power event associated with the information handling system:
intercept the power event and hold the platform controller hub from completing the power event to prevent execution of code of the basic input/output system;
attempt to verify image integrity of the basic input/output system; and
allow the platform controller hub to complete the power event to allow execution of the code of the basic input/output system responsive to successful verification of the image integrity of the basic input/output system.

2. The information handling system of claim 1, wherein the management controller is further configured to restore the basic input/output system from a restore image responsive to unsuccessful verification of the basic input/output system.

3. The information handling system of claim 2, wherein the management controller is further configured to attempt to verify image integrity of the basic input/output system as restored from the restore image.

4. The information handling system of claim 2, wherein the management controller is further configured to:
attempt to verify image integrity of the basic input/output system as restored from the restore image; and
allow the platform controller hub to complete the power event to allow execution of the code of the basic input/output system as restored from the restore image responsive to successful verification of the image integrity of the basic input/output system as restored from the restore image.

5. The information handling system of claim 4, wherein the management controller is further configured to continue to hold the platform controller hub from completing the power event to prevent execution of code of the basic input/output system responsive to unsuccessful verification of the image integrity of the basic input/output system as restored from the restore image.

6. The information handling system of claim 1, wherein:
the power event is an alternating current power event; and
prevention of execution of the code of the basic input/output system prevents execution of a management engine within the platform controller hub until successful image verification of the basic input/output system.

7. The information handling system of claim 1, wherein:
the power event is a direct current power event; and
prevention of execution of the code of the basic input/output system prevents execution of a host system of the information handling until successful image verification of the basic input/output system.

8. A method comprising, responsive to a power event associated with an information handling system:
intercepting the power event and holding a platform controller hub of the information handling system from completing the power event to prevent execution of code of a basic input/output system of the information handling system;
attempting to verify image integrity of the basic input/output system; and
allowing the platform controller hub to complete the power event to allow execution of the code of the basic input/output system responsive to successful verification of the image integrity of the basic input/output system.

9. The method of claim 8, further comprising restoring the basic input/output system from a restore image responsive to unsuccessful verification of the basic input/output system.

10. The method of claim 9, further comprising to attempting to verify image integrity of the basic input/output system as restored from the restore image.

11. The method of claim 9, further comprising:
attempting to verify image integrity of the basic input/output system as restored from the restore image; and
allowing the platform controller hub to complete the power event to allow execution of the code of the basic input/output system as restored from the restore image responsive to successful verification of the image integrity of the basic input/output system as restored from the restore image.

12. The method of claim 11, further comprising continuing to hold the platform controller hub from completing the power event to prevent execution of code of the basic input/output system responsive to unsuccessful verification of the image integrity of the basic input/output system as restored from the restore image.

13. The method of claim 8, wherein:
the power event is an alternating current power event; and
prevention of execution of the code of the basic input/output system prevents execution of a management engine within the platform controller hub until successful image verification of the basic input/output system.

14. The method of claim 8, wherein:
the power event is a direct current power event; and
prevention of execution of the code of the basic input/output system prevents execution of a host system of the information handling until successful image verification of the basic input/output system.

15. An article of manufacture comprising:
a non-transitory computer-readable medium; and
computer-executable instructions carried on the computer-readable medium, the instructions readable by a processor, the instructions, when read and executed, for causing the processor to, responsive to a power event associated with an information handling system:
intercept the power event and holding a platform controller hub of the information handling system from completing the power event to prevent execution of code of a basic input/output system of the information handling system;
attempt to verify image integrity of the basic input/output system; and
allow the platform controller hub to complete the power event to allow execution of the code of the basic input/output system responsive to successful verification of the image integrity of the basic input/output system.

16. The article of claim 15, the instructions for further causing the processor to restore the basic input/output system from a restore image responsive to unsuccessful verification of the basic input/output system.

17. The article of claim 16, the instructions for further causing the processor to attempt to verify image integrity of the basic input/output system as restored from the restore image.

18. The article of claim 16, the instructions for further causing the processor to:
attempt to verify image integrity of the basic input/output system as restored from the restore image; and
allow the platform controller hub to complete the power event to allow execution of the code of the basic input/output system as restored from the restore image responsive to successful verification of the image integrity of the basic input/output system as restored from the restore image.

19. The article of claim 18, the instructions for further causing the processor to continue to hold the platform controller hub from completing the power event to prevent execution of code of the basic input/output system responsive to unsuccessful verification of the image integrity of the basic input/output system as restored from the restore image.

20. The article of claim 15, wherein:
the power event is an alternating current power event; and
prevention of execution of the code of the basic input/output system prevents execution of a management engine within the platform controller hub until successful image verification of the basic input/output system.

21. The article of claim 15, wherein:
the power event is a direct current power event; and
prevention of execution of the code of the basic input/output system prevents execution of a host system of the information handling until successful image verification of the basic input/output system.
